(19) United States
(12) Patent Application Publication
(10) Pub. No.: US 2013/0087401 A1
(43) Pub. Date: Apr. 11, 2013

(54) VEHICLE HOOD ASSEMBLY AND METHOD FOR RAPIDLY ELEVATING THE HOOD

(71) Applicants: Anil A. MASIH, Royal Oak, MI (US); Mark J. CHOPSKI, Fenton, MI (US)

(72) Inventors: Anil A. MASIH, Royal Oak, MI (US); Mark J. CHOPSKI, Fenton, MI (US)

(73) Assignee: GM GLOBAL TECHNOLOGY OPERATIONS LLC, Detroit, MI (US)

(21) Appl. No.: 13/253,889

(22) Filed: Oct. 5, 2011

(51) Int. Cl. B60R 21/38; B62D 25/12; B60K 28/14; E05C 1/08

(52) U.S. Cl. 180/274; 180/271

(57) ABSTRACT

A hood elevation system and method are provided for a vehicle. The system includes a first member configured to couple with a body member within an engine compartment of a vehicle and a second member configured to couple with a hood latch of the vehicle and the first member. The second member is releasably slideable away from the first member upon activation of an actuator. In this way, the hood latch is elevated by the actuator moving the second member to elevate the hood of the vehicle. The method includes activating (via a controller) an actuator coupled to a first member, causing the actuator to release and slide a second member relative to the first member, the second member coupled to a hood latch engaging a hood of a vehicle to elevate the hood responsive to the controller detecting a condition.

### TECHNICAL FIELD

The technical field generally relates to hood assemblies for vehicles, and more particularly to a hood assembly capable of rapidly elevating the hood of the vehicle for the protection of pedestrians.

### BACKGROUND

Legal requirements with respect to pedestrian protection in the event of an accident with a motor vehicle are evolving. In order to decrease the consequences of injuries in the event of an impact of the pedestrian's head on the hood of a vehicle, it is desirable that the pedestrian (or his/her head) be slowed down as gradually as possible, for instance, by allowing a deformation of the hood. There must, however, be a sufficiently large space below the hood for such deformation. However, providing a large space between the hood and the underhood components can bring negative consequences into the design and performance of the vehicle (e.g., reduced aerodynamic efficiency, reduced visual appeal, reduced fuel efficiency or reduced outward visibility). To avoid the large space under the hood of the vehicle, devices are needed for automatically raising the hood in the event of an impact (or detected impending impact) to increase the distance between the hood and the engine allowing more hood deformation to occur.

Accordingly, it is desirable to provide a hood elevation feature for a vehicle. Also, it is desirable to provide a rapid hood elevation feature that facilitates the hood being re-latched so that the vehicle may be driven after an impact. Additionally, other desirable features and characteristics of the present disclosure will become apparent from the subsequent description taken in conjunction with the accompanying drawings and the foregoing technical field and background.

### BRIEF SUMMARY

In accordance with exemplary embodiments, a hood elevation system is provided for a vehicle. The system comprises a first member configured to be coupled to a body member within an engine compartment of a vehicle. Also included is a second member configured to be coupled to a hood latch of the vehicle, and is also coupled to the first member in a first position. The second member is releasably slideable away from the first member to a second position upon activation of an actuator. In this way, the hood latch is elevated by the actuator moving the second member (and the hood latch) to the second position to elevate the hood of the vehicle.

In accordance with exemplary embodiments, a hood elevation method is provided for a vehicle. The method comprises activating (via a controller) an actuator coupled to a first member, which causes the actuator to release and slide a second member relative to the first member, the second member is coupled to a hood latch engaging a hood of a vehicle to elevate the hood responsive to the controller detecting a condition.

### DESCRIPTION OF THE DRAWINGS

The subject matter will hereinafter be described in conjunction with the following drawing figures, wherein like numerals denote like elements, and:

FIG. 1 is an illustration of a vehicle suitable for using exemplary embodiments of the present disclosure;

FIG. 2 is an illustration of one embodiment of a hood latch elevation mechanism suitable for use with the hood latch assembly of FIG. 1;

FIG. 3 is a rear illustration of FIG. 2;

FIG. 4 is an illustration of the hood latch elevation mechanism of FIG. 2 including a hood latch member;

FIG. 5 is a magnified partial view of FIG. 3 illustrating the re-latch feature of the hood latch elevation mechanism according to one embodiment;

FIG. 6 is a illustration of another embodiment of a hood latch elevation mechanism suitable for use with the hood latch assembly of FIG. 1;

FIG. 7 a magnified partial view illustrating the latch release and re-latch feature of the hood latch elevation mechanism of FIG. 6; and

FIG. 8 is an illustration of the hood latch elevation mechanism of FIG. 6 in the separated (hood elevated) position.

### DETAILED DESCRIPTION

The following detailed description is merely exemplary in nature and is not intended to limit the subject matter of the disclosure or its uses. Furthermore, there is no intention to be bound by any expressed or implied theory presented in the preceding technical field, background, brief summary or the following detailed description.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

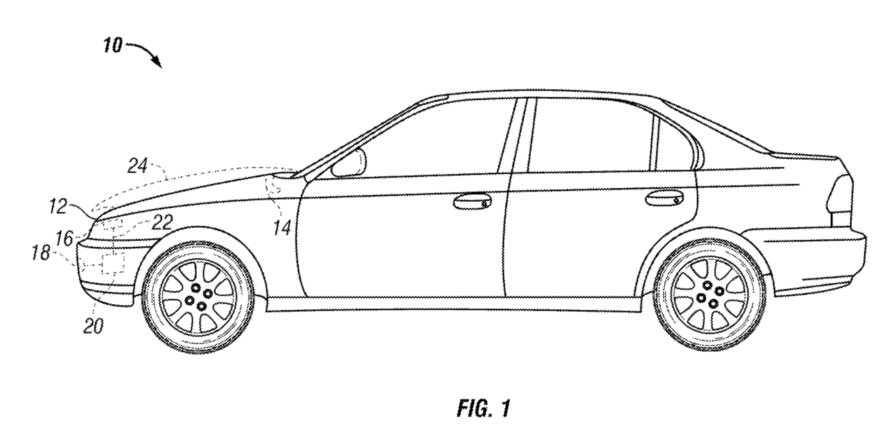

Finally, for the sake of brevity, conventional techniques and components related to vehicle electrical and mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention. It should also be understood that FIGS. 1-7 are merely illustrative and may not be drawn to scale.

Referring to the drawings, wherein like reference numbers refer to like components, FIG. 1 shows a vehicle 10 suitable for use with the exemplary mechanical embodiments of the present disclosure. The vehicle 10 may be any one of a number of different types of vehicle, such as, for example, a sedan, a wagon, a truck, or a sport utility vehicle (SUV), and may be two-wheel drive (2WD), four-wheel drive (4WD), or all-wheel drive (AWD). The vehicle 10 may also incorporate any one of, or combination of, a number of different types of engines, such as, for example, a gasoline or diesel fueled combustion engine, a flex fuel vehicle (FFV) engine (i.e., using a mixture of gasoline and alcohol), a gaseous compound (e.g., hydrogen and/or natural gas) fueled engine, a combustion/electric motor hybrid engine, and an electric motor.

The vehicle 10 includes a hood 12 that provides closure to a front compartment. In some embodiments, the vehicle engine, powertrain and other components reside in the front compartment. In embodiments having a mid or rear mounted engine, the front compartment may house other components such as spare tires, batteries, etc. Typically, the hood 12 is attached to the vehicle body with at least one, preferably a pair of, laterally spaced hinges 14. The hood 12 is held in a closed position (shown in solid lines) by a striker (not shown) coupled to the hood engaging a hood latch assembly 16. In some embodiments the hood 12 has hinges 14 mounted to its rearward portion (as illustrated) with a latch mounted in the forward portion. Alternately, the hood 12 can be configured having the hinges 14 mounted in the forward portion of the hood and latch(es) mounted in the rearward portion. According to exemplary embodiments, a sensor 18 is positioned to detect an impending or actual impact (such as with a pedestrian) and a controller 20 then activates (via conductor 22) a hood latch elevation mechanism (not shown in FIG. 1) of the hood latch assembly 16 to rapidly elevate or raise the hood to a partly open position 24 (shown in dashed lines). The controller 20 may be any one of a variety of controllers typically found on modern vehicles, such as an engine controller or may be a separate controller dedicated to the hood latch assembly 16. The controller 20 is programmed to analyze the sensor 18 data and determine if one or more conditions indicative of an impending risk of vehicle impact under the predetermined conditions exists. Elevation of the hood 12 creates more space between the hood and the underhood components (not shown) of the vehicle 10, which facilitates a more gradual deceleration of the pedestrian (or other obstacle) by allowing the hood to deform and absorb energy. According to exemplary embodiments discussed in more detail below, the hood 12 may be released by operation of an actuator that comprises a pyrotechnic or gas actuator that can rapidly elevate the hood 12 to the partly open position 24.

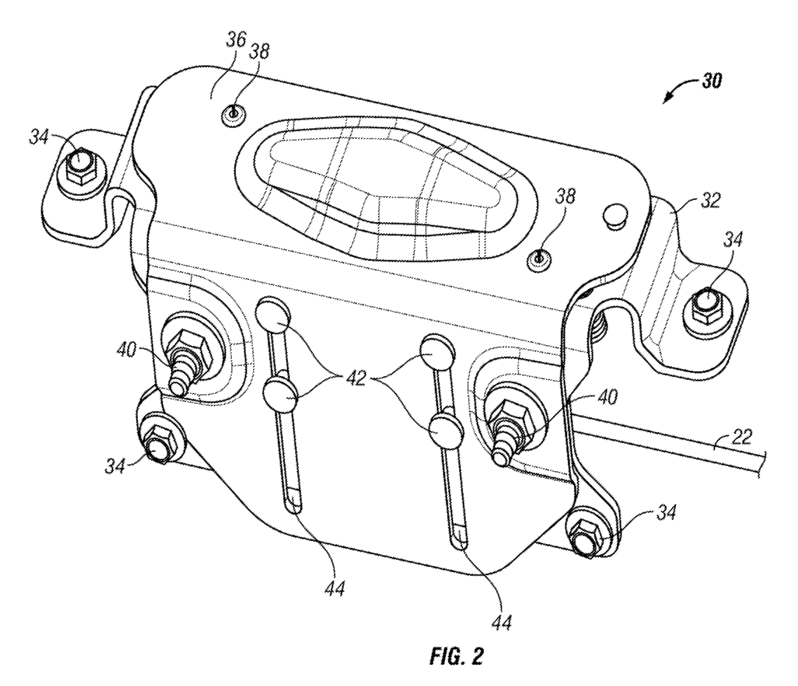

Referring now to FIG. 2, there is shown an illustration of one embodiment of a hood latch elevation mechanism 30 that in various embodiments of the present disclosure forms a supporting part of the hood latch assembly (16 in FIG. 1). The hood latch elevation mechanism 30 includes a first member 32 that is attached to a vehicle body member (e.g., tie bar) via fasteners 34. A second member 36 is coupled to the first member 32 by destructible fasteners 38 (e.g., aluminum rivets). The second member 36 includes attachment points 40 where a hood latch may be attached to the hood latch elevation mechanism 30 as part of the hood latch assembly (16 in FIG.1). The first member 32 also includes guide pins 42 that are configured in slots 44 in the second member 36. In normal operation, the first member 32 and the second member 36 are held in a coupled arrangement via destructible fasteners 38, facilitating the hood (12 in FIG. 1) to be latched or unlatched as desired by an operator of the vehicle 10.

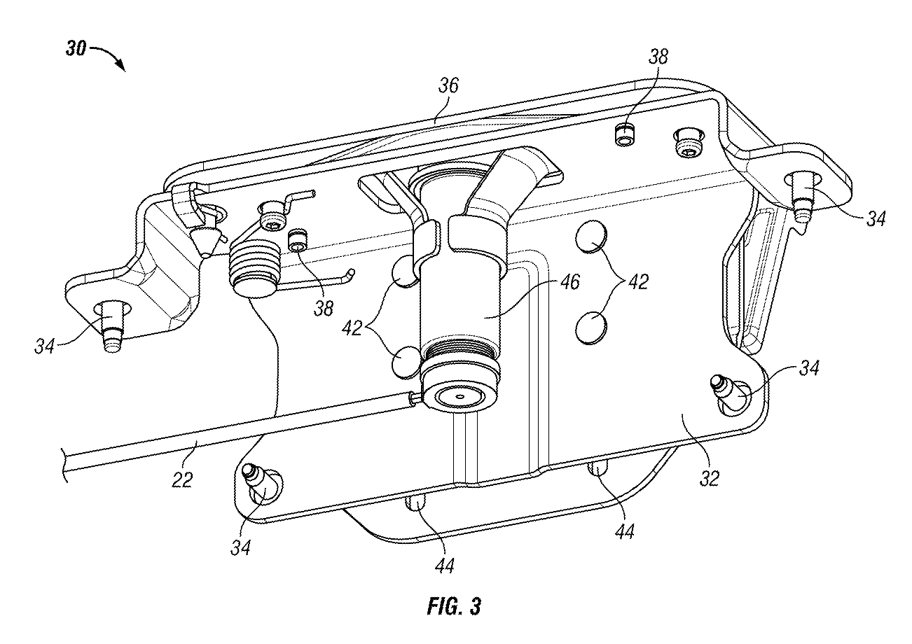

However, as illustrated in FIG. 3, in the event of an impending or detected collision, an actuator 46 is activated by the controller (20 in FIG. 1) via conductor 22 causing a rapid release and separation of the second member 36 from the first member 32. The force of the actuator 46 is sufficient to sufficiently deform destructible fasteners 38 and driving the second member 36 slideably away from the first member 32 to become separated as permitted by the guide pins 42 and slots 44.

Accordingly to exemplary embodiments, the actuator 46 can be configured to activate upon a determination by the controller (20 in FIG. 1) that a set of predetermined conditions has been met. The actuators 46 may activate upon the sensor (18 in FIG. 1) sensing an impact with the vehicle body or determining that the possibility of impact with the vehicle is greater than a predetermined amount (e.g., such as upon sensing an object in the vicinity of the vehicle 10 or upon rapid deceleration of the vehicle). In the latter arrangement, the sensor 18 monitors the environment near the front of the vehicle 10 and provides data representing the vehicle's environmental conditions the controller 20.

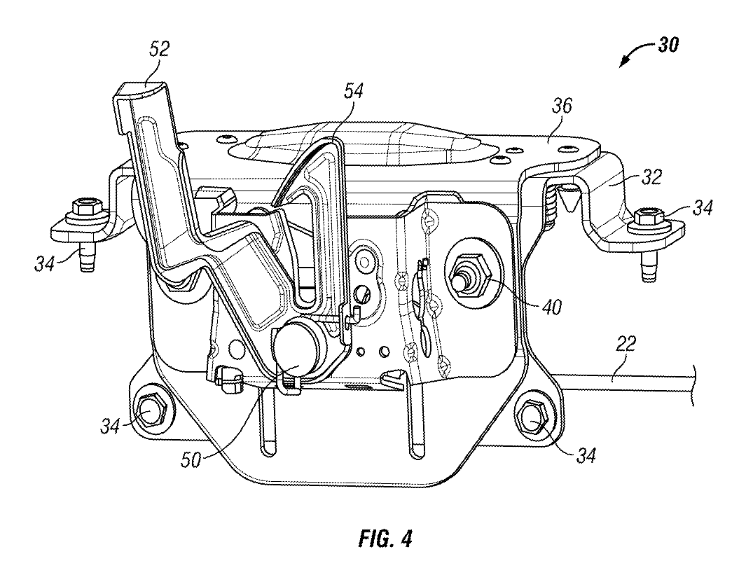

FIG. 4 is an illustration of the hood latch elevation mechanism 30, wherein like reference numbers refer to like components in previous figures, and includes an attached hood latch 50 of convention construction with an integrated secondary release apparatus 54 and secondary release lever 52. As will be appreciated, since the hood latch 50 is coupled to the second member 36 at the attachment points 40, the hood latch is elevated with the second member 36 and the hood (12 in FIG. 1). Given that the destructible fasteners 38 have been destroyed, the hood cannot be returned to a closed position and remains in the partly open position with a re-latch apparatus.

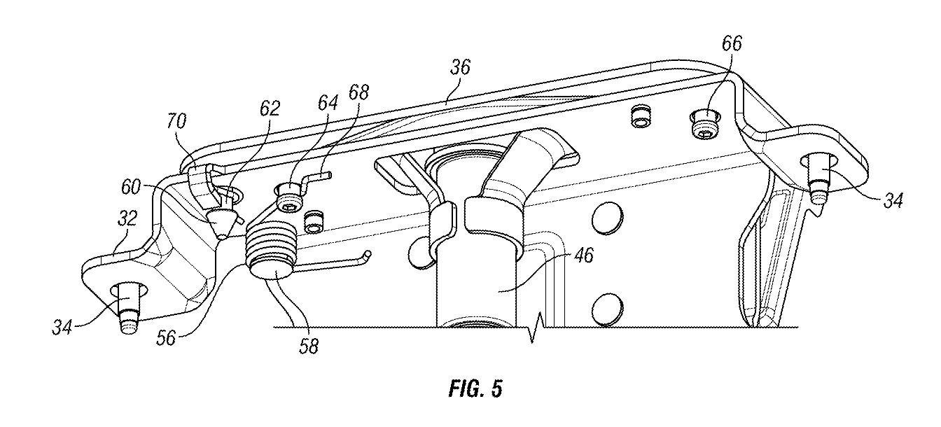

Referring now to FIG. 5, a magnified partial view of FIG. 3 illustrates a re-latch apparatus useful with exemplary embodiments of the hood latch elevation mechanism 30. In operation, the re-latch apparatus includes of a spring member 56 that pivots about a post 58, a pintle latch 60 coupled to the second member 36 via a post 62, and two guide pins 64 and 66. Prior to elevation, the spring member 56 is held out of the locking position by guide pin 64. During elevation (that is, activation of the actuator 46), the pintle latch 60 and guide post 64 are also elevated since they are attached to the second member 36. The post-elevation absence of guidepost 94 releases the spring 56 such that it rotates about post 58 until one end 64 of the spring member 56 contacts a positioning member 70. With this arrangement, the hood (12 in FIG. 1) may be re-latched via the vehicle operator pushing down on the hood surface over the latch. This action moves the hood, the hood striker, hood latch, the second member 36 and pintle 60 in a downward direction toward the first member 32. As the ramped surface pintle 60 contacts the end 68 of the spring member 56, the end 68 rotates away from positioning member 70. When the pintle 60 is moved below the end 68 of the spring member 56, the end 68 rotates back toward the positioning member 70 engaging the post 62, which retains the hood in a closed (or near closed) position. This allows the vehicle to be driven (if not too damaged) to a service center for repairs and replacement of this embodiment of the hood latch assembly (16 in FIG. 1).

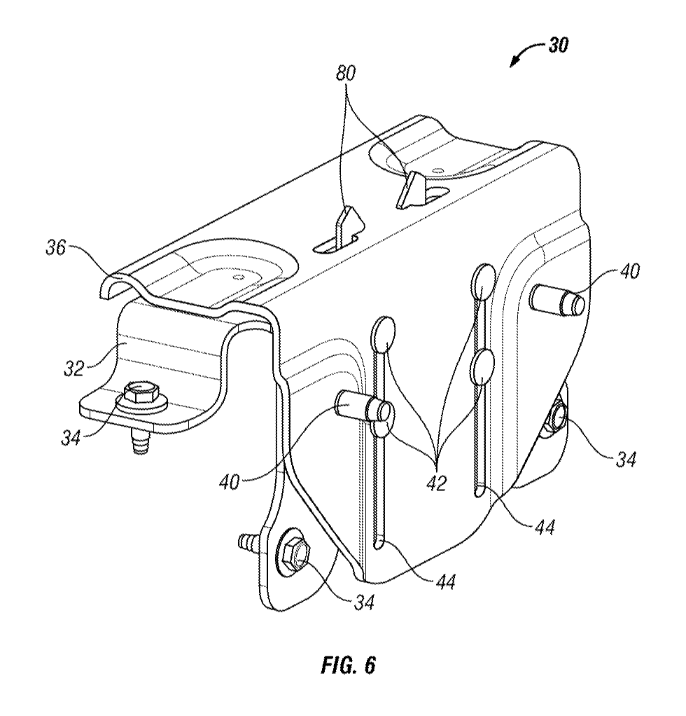

FIG. 6 illustrates an alternate embodiment of the hood latch elevation mechanism 30, wherein like reference numbers refer to like components in previous figures. In this embodiment the first member 32 and the second member 36 are coupled by releasable latches 80 that also comprise the re-latch member in this embodiment.

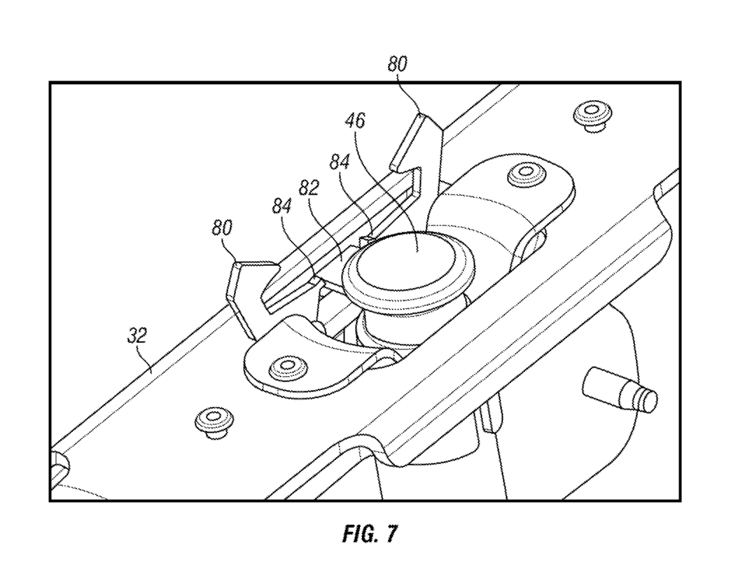

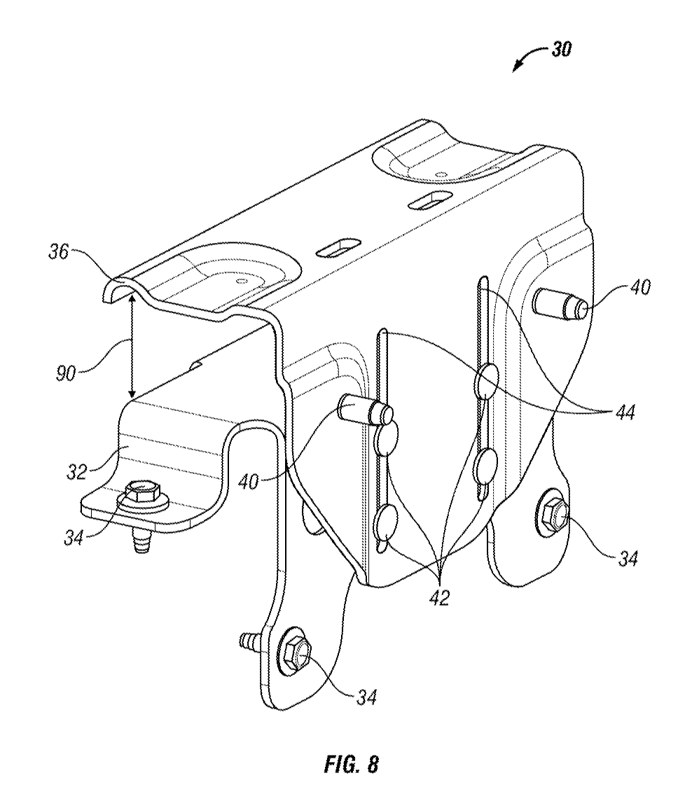

FIG. 7 is a magnified partial illustration of the hood latch elevation mechanism 30, wherein like reference numbers refer to like components in previous figures. When the actuator 46 is activated by the controller (20 in FIG. 1), a tab 82 coupled to the actuator 46 engages pins 84 of the latches 80 pushing them back to release the second member 36 from the first member 32 just as the actuator begins activation. As the actuator continues to activate, the force of the actuator (e.g., explosive force from a pyrotechnic cartridge), separates the second member 36 from the first member 32 causing the second member 36 to slide linearly away from the first member 32 via the guide pins 42 and arrangement of the slots 44 (see, FIG. 5). The resulting separation 90 is illustrated in FIG. 8, which in some embodiments may be approximately thirty to forty millimeters, although other separation distances are possible. In the embodiment of FIGS. 6-8, since the latches 80 are opened and not destroyed, the hood (12 in FIG. 1) may be closed merely by pushing the hood down to the closed position, where the latches 80 will re-couple the first member 32 to the second member 36 (see FIG. 5). Once the hood is re-latched, the vehicle may be driven (if not too damaged) to a service center for repairs and replacement of this embodiment of the hood latch assembly (16 in FIG. 1).

Accordingly, a hood elevation feature is provided for a vehicle. The exemplary embodiments of the disclosed hood elevation feature also facilitate the hood being re-latched so that the vehicle may be driven after an impact. Moreover, exemplary embodiments of the hood elevation feature may also be applied to other hood elements, such as, for example, the hinges (14 in FIG. 1) so that they may also elevate by attaching the hood hinges to the attachment points 40 of the various disclosed embodiments.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing summary and detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A vehicle, comprising:
a controller;
a hood providing closure for an engine compartment of the vehicle; and
a hood latch assembly positioned within the engine compartment and configured to retain the hood in a closed position and to elevate the hood to a partly open position responsive to the controller, the hood latch assembly comprising:
a first member coupled to a body member within the engine compartment;
a second member coupled to the first member in a first position and releaseably slideable to a second position;
a striker coupled to the hood;
a hood latch coupled to the second member and engaging the striker; and
an actuator coupled to the first member and configured to release and slide the second member to the second position when activated by the controller;
wherein, the second member and the hood latch are elevated causing the hood to move to the partly open position.

2. The vehicle of claim 1, wherein the actuator comprises a pyrotechnic cartridge.

3. The vehicle of claim 1, wherein the second member is coupled to the first member via destructible fasteners.

4. The vehicle of claim 1, wherein the second member is coupled to the first member via latches.

5. The vehicle of claim 4, wherein the latches are configured to re-couple the second member to the first member in the first position.

6. The vehicle of claim 1, further comprising a sensor coupled to the controller for detecting a condition necessitating elevation of the hood.

7. The vehicle of claim 6, wherein the condition necessitating elevation of the hood comprises a pedestrian impact with the vehicle.

8. The vehicle of claim 1, wherein the hood is elevated in a range of approximately thirty to forty millimeters.

9. A system, comprising:
a first member configured to be coupled to a body member within an engine compartment of a vehicle;
a second member coupled to the first member in a first position and releasably slideable to a second position and configured to be coupled to a hood latch of the vehicle; and
an actuator coupled to the first member and configured to release second member causing it to slide to the second position when activated;
wherein, the hood latch is elevated by the actuator moving the second member to the second position to raise a hood of the vehicle to a partly open position when the system is installed and coupled to the body member within the engine compartment of the vehicle.

10. The system of claim 9, wherein the actuator comprises a pyrotechnic cartridge.

11. The system of claim 9, wherein the second member is coupled to the first member via destructible fasteners.

12. The system of claim 9, wherein the second member is coupled to the first member via latches.

13. The system of claim 12, wherein the latches are configured to re-couple the second member to the first member in the first position.

14. The system of claim 9, wherein the second member slides a distance of approximately thirty to forty millimeters between the first position and the second position.

15. A method, comprising:
detecting a condition with a sensor;
activating an actuator coupled to a first member via a controller responsive to the detecting the condition;
releasing and sliding a second member relative to the first member resulting from the activating of the actuator; and
elevating a hood latch of a vehicle that is coupled to the second member in order to elevate the hood responsive to the detecting the condition.

16. The method of claim 15, wherein activating the actuator comprises firing a pyrotechnic cartridge.

17. The method of claim 15, wherein the controller detecting the condition comprises detecting a pedestrian impact with the vehicle.

18. The method of claim 17, further comprising re-coupling the first member and the second member after the pedestrian impact with the vehicle.

19. The method of claim 17, further comprising securing the hood to the vehicle via a re-latch member after the pedestrian impact with the vehicle.

20. The method of claim 15, wherein the releasing and sliding the second member further comprises releasing and sliding the second member approximately thirty to forty millimeters.
